(19) United States
(12) Patent Application Publication
(10) Pub. No.: US 2021/0294767 A1
(43) Pub. Date: Sep. 23, 2021

(54) COMMUNICATION METHOD AND DEVICE, ELECTRONIC DEVICE AND STORAGE MEDIUM

(71) Applicant: SHANGHAI SENSETIME INTELLIGENT TECHNOLOGY CO., LTD., Shanghai (CN)

(72) Inventors: Junwei ZHANG, Shanghai (CN); Cheng LI, Shanghai (CN)

(21) Appl. No.: 17/336,957

(22) Filed: Jun. 2, 2021

Related U.S. Application Data
(63) Continuation of application No. PCT/CN2020/095340, filed on Jun. 10, 2020.

(30) Foreign Application Priority Data
Aug. 29, 2019 (CN) 201910809368.5

(51) Int. Cl. G06F 13/38; G06K 9/32; G06F 11/10; G06F 13/40

(52) U.S. Cl. CPC G06F 13/387; G06F 13/4022; G06F 11/1004; G06K 9/3241

(57) ABSTRACT

Disclosed are a communication method and device, an electronic device and a storage medium. The method includes: acquiring a detection result obtained by performing object detection on an image frame; generating, based on the detection result and a present operation mode, a first data packet in a preset protocol format; and sending the first data packet to a lower computer, to enable the lower computer to perform image acquisition on a present scene according to the first data packet.

### CROSS-REFERENCE TO RELATED APPLICATIONS

This application is a continuation of International Application No. PCT/CN2020/095340, filed on Jun. 10, 2020, which is based upon and claims priority to Chinese Patent Application No. 201910809368.5, filed on Aug. 29, 2019. The disclosure of International Application No. PCT/CN2020/095340 and Chinese Patent Application No. 201910809368.5 are hereby incorporated by reference in their entireties.

### BACKGROUND

In the technical field of communications, the communication between an upper computer and a lower computer has an important function, especially in an embedded device. Generally, the upper computer may send a control instruction to the lower computer, and the lower computer controls a device to operate according to the received control instruction. Generally, the communication between the upper computer and the lower computer may be implemented with different communication protocols, and a complete communication protocol may guarantee reliable and efficient transmission of information.

### SUMMARY

The disclosure relates to the technical field of communications, and particularly to a communication method and device, an electronic device and a storage medium.

In embodiments of the disclosure, provided is a communication method, including: acquiring a detection result obtained by performing object detection on an image frame; generating, based on the detection result and a present operation mode, a first data packet in a preset protocol format; and sending the first data packet to a lower computer, to enable the lower computer to perform image acquisition on a present scene according to the first data packet.

In embodiments of the disclosure, provided is a communication method, including: receiving, from an upper computer, a first data packet in a preset protocol format; acquiring, based on the first data packet, a detection result and a present operation mode, wherein the detection result is obtained by performing object detection on an image frame; and performing image acquisition on a present scene according to the detection result and the present operation mode.

In embodiments of the disclosure provides is a communication device, including: an acquisition block, configured to acquire a detection result obtained by performing object detection on an image frame; a generation block, configured to generate, based on the detection result and a present operation mode, a first data packet in a preset protocol format; and a sending block, configured to send the first data packet to a lower computer, to enable the lower computer to perform image acquisition on a present scene according to the first data packet.

In embodiments of the disclosure provides is a communication device, including: a processor; and a memory, configured to store processor-executable instructions, wherein the processor is configured to call the instructions stored in the memory to: acquire a detection result obtained by performing object detection on an image frame; generate, based on the detection result and a present operation mode, a first data packet in a preset protocol format; and send the first data packet to a lower computer, to enable the lower computer to perform image acquisition on a present scene according to the first data packet.

In embodiments of the disclosure, provided is a communication device, including: a receiving block configured to receive, from an upper computer, a first data packet in a preset protocol format; a determination block configured to acquire, based on the first data packet, a detection result and a present operation mode, wherein the detection result is obtained by performing object detection on an image frame; and a control block configured to perform image acquisition on a present scene according to the detection result and the present operation mode.

In embodiments of the disclosure, provided is a communication device, including: a processor; and a memory, configured to store processor-executable instructions, wherein the processor is configured to call the instructions stored in the memory to: receive, from an upper computer, a first data packet in a preset protocol format; acquire, based on the first data packet, a detection result and a present operation mode, wherein the detection result is obtained by performing object detection on an image frame; and perform image acquisition on a present scene according to the detection result and the present operation mode.

In embodiments of the disclosure, provided is a non-transitory computer-readable storage medium having stored thereon computer program instructions that, when executed by a processor, implement the above communication methods.

In embodiments of the disclosure, provided is a computer program, including computer-readable code that, when running in an electronic device, causes a processor in the electronic device to execute the above communication methods in one or more embodiments.

It is to be understood that the above general description and the following detailed description are only exemplary and explanatory and are not intended to limit the disclosure.

According to the following detailed descriptions made to exemplary embodiments with reference to the drawings, other features and aspects of the embodiments of the disclosure would become clear.

### BRIEF DESCRIPTION OF THE DRAWINGS

The accompanying drawings, which are incorporated in and constitute a part of this specification, illustrate embodiments consistent with the disclosure and together with the description serve to describe the technical solutions of the disclosure.

FIG. 1 illustrates a flowchart of a communication method according to embodiments of the disclosure.

FIG. 2 illustrates a block diagram of an information storage format in a shared memory according to embodiments of the disclosure.

FIG. 3 illustrates a block diagram of an information storage format of a detection result according to embodiments of the disclosure.

FIG. 4 illustrates a block diagram of a format of a first data packet according to embodiments of the disclosure.

FIG. 5 illustrates a flowchart of a communication method according to embodiments of the disclosure.

FIG. 6 illustrates a block diagram of an example of a communication device according to embodiments of the disclosure.

FIG. 7 illustrates a block diagram of an example of a communication device according to embodiments of the disclosure.

FIG. 8 illustrates a block diagram of an example of an electronic device according to embodiments of the disclosure.

### DETAILED DESCRIPTION

Exemplary embodiments, features and aspects of the disclosure will be described below with reference to the drawings in detail. The same reference signs in the drawings represent components with the same or similar functions. Although various aspects of the embodiments are illustrated in the drawings, the drawings are not required to be drawn to scale, unless otherwise specified.

Special term “exemplary” refers to “use as an example, embodiment or description”. Any embodiment described to be “exemplary” may not be explained to be superior to or better than other embodiments.

In the disclosure, term “and/or” is only an association relationship describing associated objects and represents that three relationships may exist. For example, A and/or B may represent three situations: i.e., independent existence of A, existence of both A and B, and independent existence of B. In addition, term “at least one” in the disclosure represents any one of multiple, or any combination of at least two of multiple. For example, including at least one of A, B and C may represent including any one or more elements selected from a set formed by A, B and C.

In addition, for describing the embodiments of the disclosure better, many details are presented in the following implementation. It is to be understood by those skilled in the art that the embodiments of the disclosure may still be implemented even without some details. In some examples, methods, means, components and circuits known very well to those skilled in the art are not described in detail, to highlight the subject of the embodiments of the disclosure. Exemplary embodiments, features and aspects of the disclosure will be described below with reference to the drawings in detail. The same reference signs in the drawings represent components with the same or similar functions. Although various aspects of the embodiments are illustrated in the drawings, the drawings are not required to be drawn to scale, unless otherwise specified.

An information communication scheme is provided in embodiments of the disclosure. An upper computer may acquire a detection result obtained by performing object detection on an image frame, then generate a first data packet in a preset protocol format based on the detection result and a present operation mode, and send the first data packet to a lower computer, so that the lower computer performs image acquisition on a present scene according to the first data packet. In this way, the information communication between the upper computer and the lower computer is achieved. For example, the information communication between a Raspberry Pi (upper computer) and a control block (lower computer) of an intelligent robot may be achieved.

In the embodiments of the disclosure, an upper computer may acquire a detection result obtained by performing object detection on an image frame, and then, generate a first data packet in a preset protocol format based on the detection result and a present operation mode, and send the generated first data packet to a lower computer, so that the lower computer performs image acquisition on a present scene according to the first data packet. In this way, the communication between the upper computer and the lower computer can be achieved through the first data packet in the preset protocol format.

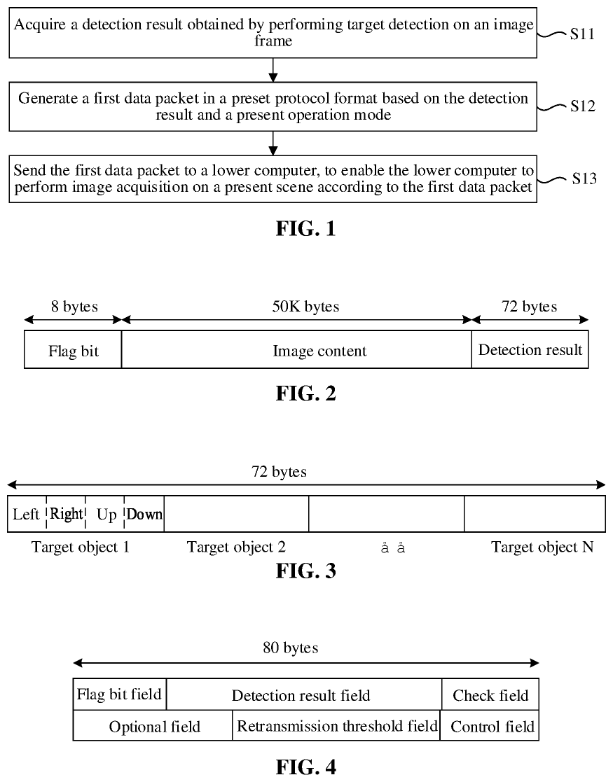

FIG. 1 illustrates a flowchart of a communication method according to embodiments of the disclosure. The communication method may be executed by a terminal device, a server or other types of electronic devices. The terminal device may be user equipment (UE), a mobile device, a user terminal, a terminal, a cell phone, a cordless telephone, a personal digital assistant (PDA), a handheld device, a computing device, a vehicle-mounted device, a wearable device, an intelligent robot and the like. In some possible implementations, the communication method may be achieved by a processor calling computer-readable instructions stored in a storage device. The communication method in the embodiments of the disclosure is described below with the communication method being executed by an electronic device as an example.

At S11, a detection result obtained by performing object detection on an image frame is acquired.

In the embodiments of the disclosure, the upper computer may acquire the detection result stored in a memory. The detection result may be obtained by performing object detection on a target object in the image frame acquired by the lower computer. For example, object detection is performed on a sphere in the image frame to obtain an object detection result for the sphere. Here, the detection result may be image coordinates of the target object in the image frame, or may be world coordinates of the target object in the three-dimensional space. For example, the Raspberry Pi may serve as the upper computer, and may be applied to an intelligent robot. The intelligent robot may acquire an image frame of the present scene in real time, and then the Raspberry Pi (upper computer) may acquire a detection result of performing object detection on the image frame.

In a possible implementation, the detection result obtained by performing object detection on the image frame may be acquired from a shared memory. Here, the upper computer may create the shared memory, and store the detection result of the image frame in the shared memory in real time, so that the upper computer may directly replicate the detection result in the shared memory, improving the efficiency in acquiring the detection result.

In an example, the shared memory may not only store the detection result, but may also store the image frame and an operation mode corresponding to the detection result in real time. The operation mode corresponding to the detection result may be an operation mode of the upper computer and the lower computer while the object detection is performed on the image frame, and the operation mode may include one or more of: a gesture classification mode, a human face detection mode, a human body tracking mode, and a sphere detection mode. The object detection performed on the image frame corresponds to the operation mode, namely, the target object for which the object detection is performed on the image frame may be determined according to the operation mode. For example, in the gesture classification mode, the target object may be a gesture image in the image frame, and in the human face detection mode, the target object may be a human face image in the image frame.

FIG. 2 illustrates a block diagram of an information storage format in a shared memory according to embodiments of the disclosure. The shared memory may include a flag bit part, an image content part and a detection result part.

The flag bit part may store a flag bit identifying an object detection state of a present image frame and an operation mode, and the object detection state may be whether the present image frame has subjected to object detection. For example, while the flag bit is 1, it may indicate that the present image frame has subjected to gesture detection. The image content part may store the present image frame. For example, every time the intelligent robot acquires an image frame, the Raspberry Pi may store the image frame in the image content part of the shared memory. The detection result part may store the detection result of performing object detection on the present image frame. For example, in a case that the object detection is human face detection, the detection result may be image coordinates or world coordinates of a human face.

Here, a corresponding storage space may be allocated for each part contained in the shared memory. For example, a storage space of 8 bytes may be allocated for the flag bit, a storage space of 50K bytes may be allocated for the image content part, and a storage space of 72 bytes may be allocated for the detection result. Here, the content cached in the shared memory may be continuously updated, namely, every time an image frame is acquired, the content of the shared memory may be updated to be the flag bit, the image content and the detection result corresponding to the present image frame.

FIG. 3 illustrates a block diagram of an information storage format of a detection result according to embodiments of the disclosure.

In an example, the detection result part of the shared memory may store a detection result of at least one target object in the present image frame, namely the image coordinates or the world coordinates of the target object. The detection result may be represented by the image coordinates or the world coordinates of multiple points. For example, the detection result part may store the detection result of N target objects, N being a positive integer greater than 0. Points on top, bottom, left and right four edges of an outline of the target object 1 may be selected, and the image coordinates or the world coordinates of the points on the four edges are taken as the detection result of the target object 1.

At S12, a first data packet in a preset protocol format is generated, based on the detection result and a present operation mode.

In the embodiments of the disclosure, the upper computer may detect the present operation mode, and then encapsulate the detection result of the present image frame and the present operation mode into the first data packet in the preset protocol format. Here, the preset protocol format may be a Transmission Control Protocol/Internet Protocol (TCP/IP) format. Here, the present operation mode may be the same as or different from the operation mode corresponding to the detection result. The present operation mode may be set by a user.

In a possible implementation, detection information may be generated according to the detection result; control information may be generated according to the present operation mode; and then the first data packet in the preset protocol format is generated by adding the detection information to a detection result field and adding the control information to a control field.

In the implementation, the first data packet may include the detection result field and the control field. The detection information generated from the detection result may be added to the detection result field, and the control information generated from the present operation mode may be added to the control field. The upper computer may directly add the detection result as the detection information to the detection result field, or may encrypt the detection result and add the encrypted detection result as the detection information to the detection result field. Correspondingly, the upper computer may directly use identification information representing the present operation mode as control information, or the upper computer may encrypt the identification information representing the present operation mode to obtain the control information. In this way, the detection information and the control information may be carried in the detection result field and the control field of the first data packet, to achieve information communication with the lower computer.

In an example of the implementation, first check information is added to a head and a tail of the detection result to generate the detection information. In the example, in order to guarantee the reliability of transmission of the detection result, the first check information may be added to the head and the tail of the detection result respectively. The first check information added to the head may be the same as or different from the first check information added to the tail. Here, the first check information may be negotiated by the upper computer and the lower computer in advance. For example, the first check information at the head is set to 0X7e, and the first check information at the tail is set to 0Xac. In this way, after receiving the first data packet, the lower computer may verify the detection information in the detection result field of the first data packet by using the first check information negotiated with the upper computer in advance. In the case that the head and the tail of the detection information are both matched with the first check information, a corresponding instruction may be executed according to the detection information; otherwise, the received first data packet may be discarded without any processing. In this way, the reliability of transmission of the detection result can be guaranteed.

At S13, the first data packet is sent to a lower computer, to enable the lower computer to perform image acquisition on a present scene according to the first data packet.

In embodiments of the disclosure, after the first data packet in the preset protocol format is generated, the upper computer may send the first data packet to the lower computer. Here, the upper computer may be connected with the lower computer in multiple manners, for example, through a serial interface or in a wireless manner. For example, a Raspberry Pi may be connected with a control block of an intelligent robot through a serial interface, and the Raspberry Pi may send the first data packet to the control block of the intelligent robot through the serial interface.

Here, after receiving the first data packet, the lower computer may parse the first data packet to acquire the detection information from the detection result field of the first data packet and to acquire the control information from the control field of the first data packet; and then the lower computer may perform a corresponding operation according to an operation mode indicated by the control information and a position of the target object indicated by the detection result, for example, tracking and shooting of the target object.

FIG. 4 illustrates a block diagram of a format of a first data packet according to embodiments of the disclosure. In a possible implementation, the first data packet may also include a check field. The above method may further include: second check information is generated; and the second check information is added to the check field of the first data packet. The second check information is used for the lower computer to verify accuracy of the first data packet.

In the implementation, the first data packet may include the check field. For example, the check field may include 16 bits. The upper computer may generate second check information, for example by using a random number, and then encrypt the detection information or the control information by using the second check information, and add the second check information to the check field of the first data packet. After receiving the first data packet, the lower computer may decrypt the detection information or the control information by using the second check information in the check field. In the case that decryption is successful, a corresponding operation may be executed according to the obtained detection result and control information; otherwise, the received first data packet may be discarded. By carrying the second check information in the check field, the accuracy of the detection information or the control information can be guaranteed, and the possibility of being tampered may be avoided.

In an example of the implementation, a preset generator polynomial may be acquired, and a binary sequence may be generated based on the generator polynomial. The second check information may be generated based on the detection result and the binary sequence.

In the example, in order to guarantee the accuracy of the detection result in an information communication process, the second check information for checking the detection result may be generated for the detection result. The generator polynomial here may be negotiated with the lower computer in advance. The generator polynomial may be a supervisory code sequence, and may be converted into the binary sequence. A number of bits contained in the binary sequence may be a positive integer, such as 8 bits, and 4 bits. For example, if the generator polynomial is G(x)=x3+x2+1, the binary sequence may be 1101. Then, a detection result D(x) and a generator polynomial G(x) are used to determine a redundant code length R, and a binary code of the D(x) is leftwards moved by R bits, to obtain a first binary code; and then the first binary code is divided by the G(x), to obtain a remainder “r”. Then, a modulo 2 operation is performed on the last R bits of the remainder “r”, to obtain a second binary code; and the second binary code may be assigned to the “r” again. Then, the binary code of the D(x) is added to the “r” after being leftwards moved by R bits, so that the second check information may be obtained. In this way, the second check information for checking the detection result may be obtained, and the accuracy of transmission of the detection result may be improved.

In a possible implementation, the first data packet may include a mode flag bit field; and the above method may further include that: an operation mode corresponding to the detection result is determined according to an operation mode used in acquiring the image frame; and the mode flag bit field of the first data packet is generated based on the operation mode corresponding to the detection result.

In the implementation, the first data packet may include the mode flag bit field, and the mode flag bit field may indicate the operation mode corresponding to the detection result. For example, while the mode flag bit field is 1, it may indicate that the operation mode corresponding to the detection result is the gesture classification mode. The upper computer may generate, according to the operation mode corresponding to the detection result, information to be stored in the mode flag bit field, and encapsulate and store the information in the mode flag bit field. After receiving the first data packet, the lower computer may determine the operation mode corresponding to the detection result according to the mode flag bit field in the first data packet. For example, it is determined that a present detection result is a human face detection result obtained in the human face detection mode, the lower computer may store the human face detection result in a storage space corresponding to the human face detection mode. In this way, the operation mode corresponding to the detection result may be determined through the mode flag bit field, thereby the lower computer may execute a corresponding operations better.

In a possible implementation, in response to that transmission time of the first data packet exceeds a retransmission threshold, and no acknowledgement information is received from the lower computer within the transmission time, the upper computer may send the first data packet to the lower computer again.

In the implementation, the upper computer may store the retransmission threshold in a retransmission threshold field of the first data packet, and the retransmission threshold may be set according to an actual application scene. After sending the first data packet, the upper computer may calculate the transmission time of the first data packet. In response to that the transmission time exceeds the retransmission threshold, and the upper computer receives no acknowledgement information returned from the lower computer for the first data packet, it may be considered that there is a problem such as that the lower computer does not receive the first data packet or that the first data packet is incorrect, and the first data packet may be sent to the lower computer again. In this way, it can be ensured that the first data packet reaches the lower computer successfully, and the communication between the upper computer and the lower computer can be guaranteed.

In a possible implementation, as illustrated in FIG. 4, the first data packet may further include an optional field. The optional field may be set according to a communication protocol format of the first data packet in the actual application scene, so that the first data packet can be improved and optimized.

In a possible implementation, the upper computer may receive a second data packet from the lower computer, and adjust the present operation mode according to control information carried in a control field of the second data packet.

In the implementation, the lower computer may be connected with multiple sensors, and receive an electrical signal transmitted from at least one of the sensors. A user may set the present operation mode through the sensor. The lower computer detects the electrical signal of the sensor to determine the operation mode set by the user. The lower computer may directly generate the control information through the present operation mode, and add the control information to the control field of the second data packet or add the encrypted control information to the control field of the second data packet, and send the second data packet to the upper computer. After receiving the second data packet, the upper computer may parse out the present operation mode from the control field of the second data packet, and adjust the operation mode of itself to the parsed out operation mode. For example, the Raspberry Pi adjusts the operation mode from the original human face detection mode to the sphere detection mode according to the second data packet transmitted from the control block of the intelligent robot. In this way, the bidirectional communication between the upper computer and the lower computer can be achieved.

It is to be noted that the upper computer may further acquire some other information from the second data packet sent by the lower computer. For example, information such as a rotation speed and a speed of the operation of the intelligent robot is acquired from the second data packet, so that the upper computer may learn the present motion state of the intelligent robot better through the bidirectional communication with the lower computer.

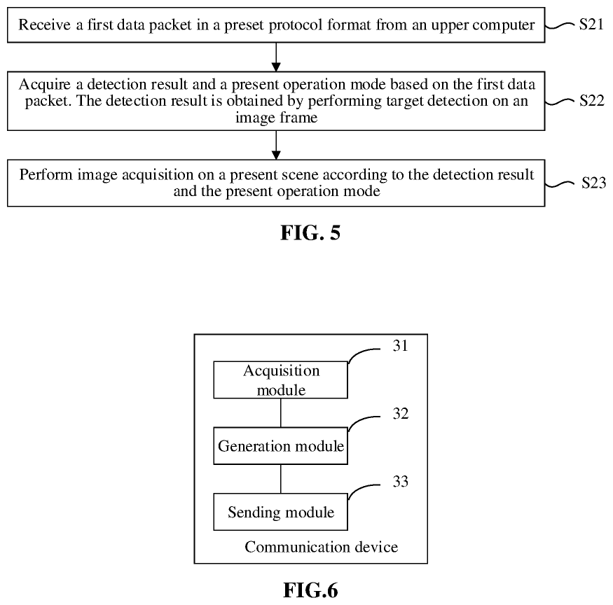

FIG. 5 illustrates a flowchart of a communication method according to embodiments of the disclosure. The communication method may be applied to a lower computer, and may include the following actions.

At S21, a first data packet in a preset protocol format is received from an upper computer.

In embodiments of the disclosure, the lower computer may receive the first data packet in the preset protocol format from the upper computer. Here, the preset protocol format may be a TCP/IP format. For example, a control block (lower computer) of the intelligent robot may receive a first data packet from a Raspberry Pi (upper computer) through a serial interface.

At S22, based on the first data packet, a detection result obtained by performing object detection on an image frame and a present operation mode are acquired.

Here, the lower computer may acquire, from the detection result field of the first data packet, the detection result obtained by performing object detection on the image frame, and acquire the present operation mode from the control field of the first data packet. Here, the operation mode may include one or more of: a gesture classification mode, a human face detection mode, a human body tracking mode, and a sphere detection mode.

At S23, according to the detection result and the present operation mode, image acquisition is performed on a present scene.

Here, the lower computer may determine a position of a target object according to the detection result, and the position may be world coordinates or image coordinates of the target object. Then, according to the present operation mode and the position of the target object indicated by the detection result, corresponding image acquisition is performed. For example, tracking and shooting are performed on the target object. In this way, the information communication between the upper computer and the lower computer may be achieved.

In a possible implementation, the lower computer may acquire detection information from a detection result field of the first data packet, and acquire, according to the detection information, the detection result obtained by performing the object detection on the image frame. Correspondingly, the lower computer may acquire control information from a control field of the first data packet, and determine the present operation mode according to the control information.

In the implementation, the lower computer may directly acquire the detection result of the target object through the detection information in the detection result field, or may decrypt the detection information in the detection result field in a mode negotiated with the upper computer in advance, to obtain the detection result of the target object. Correspondingly, the lower computer may directly acquire the present operation mode through the control information in the control field, or may decrypt the control information in the control field in a mode negotiated with the upper computer in advance, to obtain the present operation mode. In this way, the accuracy of content in the first data packet may be guaranteed.

In a possible implementation, the lower computer may acquire first check information at a head and a tail of the detection information. In the case that the first check information is matched with preset check information, the detection result is extracted from the detection information. In the implementation, the first check information may be negotiated between the upper computer and the lower computer in advance, and the first check information at the head and the tail of the detection information may be the same as or different from each other. For example, the first check information at the head may be set to 0X7e, and the first check information at the tail may be set to 0Xac. After receiving the first data packet, the lower computer may verify the detection information in the detection result field of the first data packet by using the first check information negotiated with the upper computer in advance. In the case that the head and the tail of the detection information are both matched with the first check information, the present operation mode may be determined by the detection information. Otherwise, the received first data packet may be discarded without any processing. In this way, the reliability of transmission of the detection result may be guaranteed.

In an example of the implementation, the lower computer may acquire second check information from a check field of the first data packet, and acquire a binary sequence generated by a preset generator polynomial. Then, the second check information is checked by using the binary sequence, to obtain a check result; and in response to that the check result is that the check is passed, the detection result is acquired from the first data packet.

In the example, in order to guarantee the accuracy of the detection result in an information communication process, second check information may be set for the detection result. The second check information may be carried in the check field of the first data packet. The lower computer may acquire a pre-stored generator polynomial and generate a binary sequence through the generator polynomial, or the lower computer directly acquires a stored binary sequence. Then, the second check information is divided by the binary sequence, to obtain a remainder. In the case that the remainder is 0, it may be considered that a check result indicates is the check is passed. Otherwise, it may be considered that the check result is that the check is not passed. In the case that the check is passed, the detection result may be acquired from the detection result field; and in the case of failing to pass the check, the first data packet may be discarded. In this way, the lower computer may acquire the detection result accurately, and the detection result may be prevented from being tampered.

In a possible implementation, the method may further include that: the present operation mode is detected; in response to that the operation mode is changed, the control field of the first data packet is modified based on the present operation mode, to obtain a second data packet; and the second data packet is sent to the upper computer.

In the implementation, the lower computer may be connected with multiple sensors, for example, a touch sensor, a light sensor, and an infrared sensor. An electrical signal transmitted by at least one of the sensors is received, and a user may set the present operation mode through the sensor. The lower computer detects the electrical signal of the sensor to determine the operation mode set by the user. The lower computer may directly generate control information through the present operation mode, and add the control information to a control field of the second data packet, or may add the encrypted the control information to the control field of the second data packet, and send the second data packet to the upper computer. Thus the upper computer may adjust the present operation mode according to the control field in the second data packet. In this way, the information communication process from the lower computer to the upper computer can be achieved.

It is to be noted that, in addition to sending the present operation mode to the upper computer through the control field of the second data packet, the lower computer may actively send some other information to the upper computer. For example, information such as a rotation speed and a speed of the operation of the intelligent robot carried in the second data packet is sent to the upper computer.

Through the information communication scheme provided by the embodiments of the disclosure, the information communication between the upper computer and the lower computer is achieved. For example, the information communication between the Raspberry Pi (upper computer) and the control block (lower computer) of the intelligent robot may be achieved.

An education robot mindstorms-EV3 built by combining Lego and the Raspberry Pi is currently a new teaching aid for programming education and artificial intelligence popularization. The bidirectional communication between the Lego and the Raspberry Pi is a most basic problem. Communication between the upper and lower computers may be realize by using a state register, a task unit sequence and the like in the related art.

The technology of communication between upper and lower computers has an important function in many fields, especially in an embedded device. The reliable and efficient data transmission may be guaranteed by a complete communication protocol. However, it is more difficult to design and achieve a complete and unified protocol. Firstly, a protocol specification depends on a relevant hardware interface, and upper and lower computer devices and connection modes thereof are also diverse, making it impossible to set a unified standard. In addition, in order to guarantee the reliability of data transmission, a check mechanism and a retransmission mechanism are needed. However, retransmission and check may reduce the real-time performance of the data transmission to a certain extent, resulting in that the protocol needs to be modified according to different requirement scenes. Finally, the protocol should also be designed to achieve bidirectional interaction between the upper and lower computers.

In embodiments of the disclosure, a communication protocol between Raspberry Pi and EV3 is designed. The protocol may solve a communication problem between the Raspberry Pi and EV3, and may mainly include the following actions S31 to S36.

At S31, a shared memory is created in Raspberry Pi, to store information such as a flag bit, a picture and a picture detection result.

The embodiments of the disclosure are mainly applied to intelligent robots in education. The intelligent robot can achieve functions such as gesture classification, human face detection, and human body tracking. A bidirectional communication protocol between Raspberry Pi and Lego EV3 is provided in the embodiments of the disclosure. Picture acquisition and picture detection tasks of different functions are achieved in the Raspberry Pi. In order to achieve picture storage, detection result storage, and switching of the different functions, a shared memory is created in the Raspberry Pi, and a main information format in the shared memory is as illustrated in FIG. 2.

The information format in the shared memory in FIG. 2 may mainly include three parts of content: a flag bit, a picture content and a detection result. A function of the flag bit is to identify whether a present acquired picture has subjected to detection processing, and to identify different detection function modes. A picture content part is a picture storage area, and acquired video data may be framed and stored in the part. A detection result part stores picture detection information, has a size of 72 Bytes. The detection result part is mainly used for storing detection result information of multiple objects, and the information is as illustrated in FIG. 3. The flag bit and the picture content are continuously updated for each frame, but do not serve as content of transmitted data, and the detection result information of each frame is encapsulated in the data packet.

At S32, the flag bit in the shared memory is changed to perform detection on the next frame of picture; and detection result information is encapsulated as a data field.

The detection result part in the shared memory may be input, and the data packet encapsulated with the detection result may be output. Based on the detection result in the shared memory of the Raspberry Pi, a corresponding field is filled to a designated part so as to achieve data encapsulation. A data packet format is as illustrated in FIG. 4.

A function mode field and a detection result information field are both reserved in the shared memory, and the detection result information is directly encapsulated into a corresponding detection information part. In order to guarantee the reliability of transmission of the detection data, a check byte is added to both the head and the tail of the detection result. The check byte at the head may be 0X7e, and the tail byte may be 0Xac.

After receiving the data packet, the EV3 may firstly parse out the detection result field, and then check the head-byte and tail-byte information. When the check is passed, a corresponding instruction is executed according to the detection result; and when the check is not passed, the data packet may be discarded without any processing.

At S33, a CRC check field is calculated according to a data field.

In order to guarantee the accuracy of a transmission result, a Cyclic Redundancy Check (CRC) check field is added to the data packet. The field is only used for checking the detection result, and check bits contain 16 bytes of information totally. While parsing the data packet, the EV3 side also performs CRC check to obtain a detection result sequence. The data packet may be discarded while the check is not passed.

TABLE 1

| Type | Serial Number |
|---|---|
| Gesture classification | 1 |
| Human face detection | 2 |
| Human body tracking | 3 |
| Sphere detection | 4 |

The education robot has different operation modes, the EV3 and the Raspberry Pi need to start corresponding services at the same time in the different operation modes. Starting and switching of the services need to be set through the control field, and the services and the corresponding control types are illustrated above in Table 1. At a Raspberry Pi side, a service type of its own is firstly detected, and the content of the control field is filled according to the service type.

In addition, a retransmission threshold field is reserved in the data packet format. After the time threshold is set, once no corresponding Acknowledge character (ACK) reply message is received until the data packet transmission time exceeds the threshold, the above data packet will be resent. Because this education robot is connected through a wired serial port, and a packet loss rate is extremely low, so the field is a reserved field and is reserved for use in a wireless scene.

After completing the above data information encapsulation of the data packet, the Raspberry Pi sends the data packet through a serial port. The sending of the data packet is achieved through an instruction of a bottom layer of an operating system.

At S35, EV3 receives a data packet, executes a corresponding instruction, completes checking, and modify a control field through a touch sensor.

The EV3 may complete two functions: receiving and parsing the data packet sent from the Raspberry Pi; and modifying the data packet control field and sending the data packet to the Raspberry Pi.

Firstly, after receiving the data packet, the EV3 side firstly performs CRC check, parses the detection result when the check is passed, and executes a corresponding instruction according to the detection result. A CRC check process may include the following actions S351 to S354.

At S351, the data packet is parsed to obtain a detection result sequence.

At S352, the detection result sequence is divided by a preset generator polynomial, to obtain a remainder.

At S353, if the remainder is 0, the check is passed, and the detection result is correct.

At S354, if the remainder is not 0, the check is not passed, and the detection result is incorrect.

Secondly, while the function mode is modified by a related sensor at the EV3 side through such as a touch sensor or an infrared beacon, the control field in the data packet is modified, and the information is sent to the Raspberry Pi side. The service started at the Raspberry Pi side is adjusted, so as to guarantee the consistency between the services of the upper and lower computers.

At S36, the Raspberry Pi receives the control field information from the EV3, and adjust the operation mode.

After receiving the data packet, the Raspberry Pi side firstly completes the CRC check, and parses the control field after the check is passed, and adjust the operation mode of itself through the control field. In this case, the format of the shared memory of the Raspberry Pi remains unchanged, including three parts: a flag bit, a picture content and a detection result; however the detection result corresponds to the detection information under a different function.

According to the embodiments of the disclosure, by designing the data field and the control field in communication protocol between the Raspberry Pi and the EV3, transmission of the data information and the control information can be completed. Then, by improving the retransmission mechanism and the CRC checking method, the reliable and efficient transmission of data is guaranteed. With the help of the touch sensor of the EV3, the switching between the different function modes of the upper and lower computers (for example, the Raspberry Pi and the EV3) are achieved, completing the different operation modes of the education robot, and guaranteeing the consistency of the data information. The communication protocol between the Raspberry Pi and the EV3 is reserved with other optional communication protocol fields, may be applied to other similar devices, and can be improved and optimized conveniently.

The embodiments of the disclosure are based on the TCP/IP protocol, are compatible with the different upper and lower computer devices in the serial port communication mode, and are weakly dependent on hardware devices. Comparatively, the related art is often dependent on an embedded device.

The embodiments of the disclosure are capable of achieving a more flexible bidirectional information interaction mechanism between the upper and lower computers, and conveniently achieving the weak control over the upper computer by the lower computer. In most cases in the related art, only the control over the lower computer by the upper computer is realized.

According to the embodiments of the disclosure, in the communication protocol between the Raspberry Pi and the EV3, the data types are divided into two parts, i.e., the data field and the control field, thus the reliability of data transmission can be improved. The switching between different modes of the education robot may be achieved by the control field. Data types are not classified in existing protocols, and it is relatively solid.

In the embodiments of the disclosure, the CRC checking method is improved. A length of a cyclic code can be freely adjusted by customization, and a compromise between reliability and efficiency is achieved. Comparatively, the length of the cyclic code is usually fixed in a traditional CRC method.

The embodiments of the disclosure may be applied to education robots, the field of semiconductor, or embedded devices. In the application scene of an education robot, the reliable bidirectional communication between a control device and an execution device may be guaranteed by the communication protocol between the Raspberry Pi and the EV3. In the semiconductor field or the embedded devices, the algorithm may provide a flexible bidirectional interaction mechanism. The communication efficiency may be improved by using the improved CRC checking scheme in the embodiments of the disclosure. The shared memory described in the embodiments of the disclosure may be used to facilitate switching between the different function modes in the upper computer.

It may be understood that the various method embodiments mentioned in the disclosure may be combined with each other to form a combined embodiment without violating principle and logic, which will not be described here again.

In addition, a device, an electronic device, a computer readable storage medium, and a program are also provided in the disclosure, all of which may be configured to achieve any one of the communication methods provided in the disclosure. Corresponding technical schemes and descriptions may refer to the corresponding content in the method part, and are not be repeatedly described.

It may be understood by those skilled in the art that in the above methods of the implementation, a writing sequence of actions does not mean a strict execution sequence and is not intended to form any limit to the implementation process, and an execution sequence of the actions should be determined by functions and possible internal logic thereof.

FIG. 6 illustrates a block diagram of an example of a communication device according to embodiments of the disclosure. As illustrated in FIG. 6, the device may include: an acquisition block 31, a generation block 32 and a sending block 33.

The acquisition block 31 is configured to acquire a detection result obtained by performing object detection on an image frame.

The generation block 32 is configured to generate, based on the detection result and a present operation mode, a first data packet in a preset protocol format.

The sending block 33 is configured to send the first data packet to a lower computer, to enable the lower computer to perform image acquisition on a present scene according to the first data packet.

In a possible implementation, the acquisition block 31 is configured to acquire, from a shared memory, the detection result obtained by performing object detection on the image frame.

In a possible implementation, the generation block 32 is configured to: generate detection information according to the detection result; generate control information according to the present operation mode; and generate the first data packet in the preset protocol format by adding the detection information to a detection result field and by adding the control information to a control field.

In a possible implementation, the generation block 32 is configured to generate the detection information by adding first check information to a head and a tail of the detection result.

In a possible implementation, the first data packet may include a check field; and the generation block 32 is further configured to: generate second check information; add the second check information to the check field of the first data packet. The second check information is used for the lower computer to verify accuracy of the first data packet.

In a possible implementation, the generation block 32 is configured to: acquire a preset generator polynomial; generate a binary sequence based on the generator polynomial; and generate the second check information based on the detection result and the binary sequence.

In a possible implementation, the first data packet may include a mode flag bit field. The generation block 32 is further configured to: determine an operation mode corresponding to the detection result, according to an operation mode used in acquiring the image frame; and generate the mode flag bit field of the first data packet based on the operation mode corresponding to the detection result.

In a possible implementation, the sending block 33 is further configured to: in response to that transmission time of the first data packet exceeds a retransmission threshold, and no acknowledgement information is received from the lower computer within the transmission time, send the first data packet to the lower computer again.

In a possible implementation, the device may further include a receiving block. The receiving block is configured to: receive a second data packet from the lower computer; and adjust the present operation mode according to control information carried in a control field of the second data packet.

In a possible implementation, the operation mode may include at least one of the following: a gesture classification mode, a human face detection mode, a human body tracking mode, or a sphere detection mode.

FIG. 7 illustrates a block diagram of an example of a communication device according to embodiments of the disclosure. As illustrated in FIG. 7, the device may include: a receiving block 41, a determination block 42, and a control block 43.

The receiving block 41 is configured to receive, from an upper computer, a first data packet in a preset protocol format.

The determination block 42 is configured to acquire, based on the first data packet, a detection result and a present operation mode. The detection result is obtained by performing object detection on an image frame.

The control block 43 is configured to perform image acquisition on a present scene according to the detection result and the present operation mode.

In a possible implementation, the determination block 42 is configured to: acquire detection information from a detection result field of the first data packet; acquire, according to the detection information, the detection result obtained by performing object detection on the image frame; acquire control information from a control field of the first data packet; and determine the present operation mode according to the control information.

In a possible implementation, the determination block 42 is configured to: acquire first check information at a head and a tail of the detection information; and in response to that the first check information is matched with preset check information, extract the detection result from the detection information.

In a possible implementation, the determination block 42 is configured to: acquire second check information from a check field of the first data packet; acquire a binary sequence generated by a preset generator polynomial; check the second check information by using the binary sequence, to obtain a check result; and in response to that the check result is that the check is passed, acquire the detection result from the first data packet.

In a possible implementation, the device may further include a modification block. The modification block is configured to detect the present operation mode; in response to that the present operation mode is changed, modify the control field of the first data packet based on the present operation mode, to obtain a second data packet; and send the second data packet to the upper computer.

In a possible implementation, the operation mode may include at least one of the following: a gesture classification mode, a human face detection mode, a human body tracking mode, or a sphere detection mode.

In some embodiments, the functions or blocks included in the devices provided in the embodiments of the disclosure may be used to execute the methods described in the above method embodiments, and the implementations thereof may refer to the descriptions of the above method embodiments, and will not be described here again for brevity.

In embodiments of the disclosure, further provided is an electronic device, including: a processor; and a memory configured to store processor-executable instructions. The processor is configured to perform the above methods.

The electronic device may be provided as a terminal, a server, or other forms of devices.

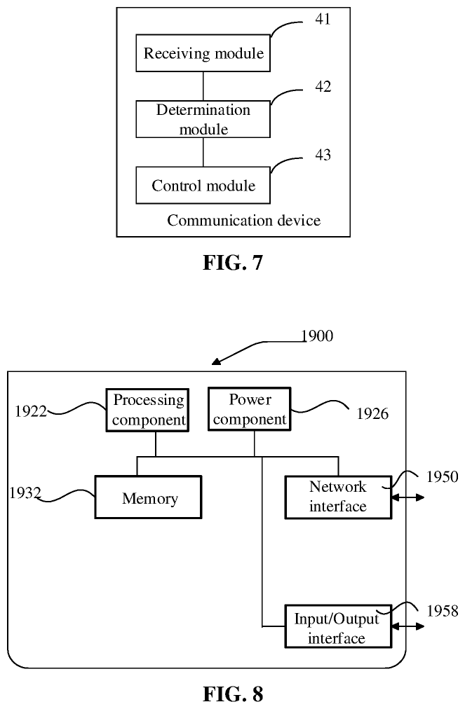

FIG. 8 illustrates a block diagram of an electronic device 1900 according to an exemplary embodiment. For example, the electronic device 1900 may be provided as a server. As illustrated in FIG. 8, the electronic device 1900 includes a processing component 1922 further including one or more processors, and a memory resource represented by a memory 1932, configured to store instructions executable for the processing component 1922, for example, an application program. The application program stored in the memory 1932 may include one or more blocks each corresponding to a set of instructions. In addition, the processing component 1922 is configured to execute the instructions to execute the above methods.

The electronic device 1900 may further include a power component 1926 configured to execute power management of the electronic device 1900, a wired or wireless network interface 1950 configured to connect the electronic device 1900 to a network, and an Input/Output (I/O) interface 1958. The electronic device 1900 may be operated based on an operating system stored in the memory 1932, for example, Windows Server™, Mac OS X™, Unix™, Linux™, FreeBSD™ or the like.

In the exemplary embodiment, a nonvolatile computer-readable storage medium is further provided, for example, a memory 1932 including computer program instructions. The computer program instructions may be executed by a processing component 1922 of an electronic device 1900 to implement the above methods.

The disclosure may be a system, a method and/or a computer program product. The computer program product may include a computer-readable storage medium having stored thereon computer-readable program instructions configured to enable a processor to implement each aspect of the disclosure.

The computer-readable storage medium may be a tangible device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. Examples (non-exhaustive list) of the computer-readable storage medium include a portable computer disk, a hard disk, a Random Access Memory (RAM), a Read-Only Memory (ROM), an Erasable Programmable Read-Only Memory (EPROM) (or a flash memory), an Static Random-Access Memory (SRAM), a Compact Disc Read-Only Memory (CD-ROM), a Digital Video Disk (DVD), a memory stick, a floppy disk, a mechanical encoding device, a punched card or in-slot raised structure with instructions stored therein, and any appropriate combination thereof. The computer-readable storage medium is not explained as a transient signal, for example, radio waves or other freely propagating electromagnetic waves, electromagnetic waves propagating through a waveguide or another transmission medium (for example, an optical pulse propagating through an optical fiber cable) or an electric signal transmitting through an electric wire.

The computer-readable program instructions described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instructions configured to execute the operations of the disclosure may be assembly instructions, Instruction Set Architecture (ISA) instructions, machine instructions, machine related instructions, microcode, firmware instructions, state setting data or a source code or target code edited by one or any combination of more programming languages, the programming language including an object-oriented programming language such as Smalltalk and C++ and a conventional procedural programming language such as “C” language or a similar programming language. The computer-readable program instructions may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be connected with the computer of the user through any type of network including a Local Area Network (LAN) or a Wide Area Network (WAN), or, may be connected with an external computer (for example, by an Internet service provider through the Internet). In some embodiments, an electronic circuit such as a programmable logic circuit, a Field Programmable Gate Array (FPGA) or a Programmable Logic Array (PLA) may be customized by use of state information of a computer-readable program instruction, and the electronic circuit may execute the computer-readable program instruction, thereby implementing each aspect of the disclosure.

Each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby producing a machine to further generate a device that realizes a function/action specified in one or more blocks in the flowcharts and/or the block diagrams when the instructions are executed by the computer or the processor of the other programmable data processing devices. These computer-readable program instructions may also be stored in a computer-readable storage medium, and through these instructions, the computer, the programmable data processing device and/or another device may work in a specific manner, so that the computer-readable medium including the instructions includes a product containing instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to produce a computer-implemented process, so that the function/action specified in one or more blocks in the flowcharts and/or the block diagrams are realized by the instructions executed in the computer, the other programmable data processing device or the other device.

Correspondingly, the embodiments of the disclosure further provide a computer program, including computer readable code that, when running in an electronic device, causes a processor in the electronic device to execute any one of the communication methods provided by the embodiments of the disclosure.

The flowcharts and block diagrams in the drawings illustrate possibly implementable system architectures, functions and operations of the system, method and computer program product according to multiple embodiments of the disclosure. On this aspect, each block in the flowcharts or the block diagrams may represent part of a block, a program segment or an instructions, and the part of the block, the program segment or the instructions includes one or more executable instructions configured to realize a specified logical function. In some alternative implementations, the functions marked in the blocks may also be realized in a sequence different from that marked in the drawings. For example, two continuous blocks may actually be executed substantially concurrently and may also be executed in a reverse sequence sometimes, which depends on the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Various embodiments of the disclosure have been described above. The above descriptions are exemplary, non-exhaustive and also not limited to each disclosed embodiment. Many modifications and variations would be apparent to those of ordinary skill in the art without departing from the scope and spirit of each described embodiment of the disclosure. The terms used herein are selected to explain the principle and practical application of the various embodiments, or improvements to the technologies in the market best or enable others of ordinary skill in the art to understand the various embodiments disclosed herein.

1. A communication method, comprising:
acquiring a detection result obtained by performing object detection on an image frame;
generating, based on the detection result and a present operation mode, a first data packet in a preset protocol format; and
sending the first data packet to a lower computer, to enable the lower computer to perform image acquisition on a present scene according to the first data packet.

2. The method of claim 1, wherein acquiring the detection result obtained by performing object detection on the image frame comprises:
acquiring, from a shared memory, the detection result obtained by performing object detection on the image frame.

3. The method of claim 1, wherein generating, based on the detection result and the present operation mode, the first data packet in the preset protocol format comprises:
generating detection information according to the detection result;
generating control information according to the present operation mode; and
generating the first data packet in the preset protocol format by adding the detection information to a detection result field and by adding the control information to a control field.

4. The method of claim 3, wherein generating the detection information according to the detection result comprises:
generating the detection information by adding first check information to a head and a tail of the detection result.

5. The method of claim 1, wherein the first data packet comprises a check field, and the method further comprises:
generating second check information; and
adding the second check information to the check field of the first data packet, wherein the second check information is used for the lower computer to verify accuracy of the first data packet.

6. The method of claim 5, wherein generating the second check information comprises:
acquiring a preset generator polynomial;
generating a binary sequence based on the preset generator polynomial; and
generating the second check information based on the detection result and the binary sequence.

7. The method of claim 1, wherein the first data packet comprises a mode flag bit field, and the method further comprises:
determining an operation mode corresponding to the detection result, according to an operation mode used in acquiring the image frame; and
generating the mode flag bit field of the first data packet based on the operation mode corresponding to the detection result.

8. The method of claim 1, further comprising:
in response to that transmission time of the first data packet exceeds a retransmission threshold, and no acknowledgement information is received from the lower computer within the transmission time, sending the first data packet to the lower computer again.

9. The method of claim 1, further comprising:
receiving a second data packet from the lower computer; and
adjusting the present operation mode according to control information carried in a control field of the second data packet.

10. The method of claim 1, wherein the operation mode comprises at least one of the following:
a gesture classification mode,
a human face detection mode,
a human body tracking mode, or
a sphere detection mode.

11. A communication method, comprising:
receiving, from an upper computer, a first data packet in a preset protocol format;
acquiring, based on the first data packet, a detection result and a present operation mode, wherein the detection result is obtained by performing object detection on an image frame; and
performing image acquisition on a present scene according to the detection result and the present operation mode.

12. The method of claim 11, wherein acquiring, based on the first data packet, the detection result and the present operation mode, wherein the detection result is obtained by performing object detection on the image frame comprises:
acquiring detection information from a detection result field of the first data packet;
acquiring, according to the detection information, the detection result obtained by performing object detection on the image frame;
acquiring control information from a control field of the first data packet; and
determining the present operation mode according to the control information.

13. The method of claim 12, wherein acquiring, according to the detection information, the detection result obtained by performing object detection on the image frame comprises:
acquiring first check information at a head and a tail of the detection information; and
in response to that the first check information is matched with preset check information, extracting the detection result from the detection information.

14. The method of claim 12, wherein acquiring the detection information from the detection result field of the first data packet comprises:
acquiring second check information from a check field of the first data packet;
acquiring a binary sequence generated by a preset generator polynomial;
checking the second check information by using the binary sequence, to obtain a check result; and
in response to that the check result is that the check is passed, acquiring the detection result from the first data packet.

15. The method of claim 11, further comprising:
detecting the present operation mode;
in response to that the present operation mode is changed, modifying a control field of the first data packet based on the present operation mode, to obtain a second data packet; and
sending the second data packet to the upper computer.

16. The method of claim 11, wherein the operation mode comprises at least one of the following:
a gesture classification mode,
a human face detection mode,
a human body tracking mode, or
a sphere detection mode.

17. A communication device, comprising:
a processor; and
a memory, configured to store processor-executable instructions;
wherein the processor is configured to call the processor-executable instructions stored in the memory to:
acquire a detection result obtained by performing object detection on an image frame;
generate, based on the detection result and a present operation mode, a first data packet in a preset protocol format; and
send the first data packet to a lower computer, to enable the lower computer to perform image acquisition on a present scene according to the first data packet.

18. A communication device, comprising:
a processor; and
a memory, configured to store processor-executable instructions;
wherein the processor is configured to call the processor-executable instructions stored in the memory to execute the method of claim 11.

19. A non-transitory computer-readable storage medium having stored thereon computer program instructions that, when executed by a processor, implement the method of claim 1.

20. A non-transitory computer-readable storage medium having stored thereon computer program instructions that, when executed by a processor, implement the method of claim 11.
